(19) United States
(12) Patent Application Publication
(10) Pub. No.: US 2022/0004041 A1
(43) Pub. Date: Jan. 6, 2022

(54) DISPLAY DEVICE

(71) Applicant: Shenzhen China Star Optoelectronics Semiconductor Display Technology Co., Ltd., Shenzhen, Guangdong (CN)

(72) Inventor: Bo HAI, Shenzhen, Guangdong (CN)

(73) Assignee: Shenzhen China Star Optoelectronics Semiconductor Display Technology Co., Ltd., Shenzhen, Guangdong (CN)

(21) Appl. No.: 17/047,732

(22) PCT Filed: Aug. 3, 2020
(86) PCT No.: PCT/CN2020/106545

§ 371 Date: Oct. 15, 2020

(30) Foreign Application Priority Data
Jul. 1, 2020 (CN) 202010623231.3

(51) Int. Cl. G02F 1/13357; G02F 1/1335

(52) U.S. Cl. CPC G02F 1/13362; G02F 1/133528; G02F 2201/50; G02F 2202/28; G02F 1/133504

(57) ABSTRACT

The present disclosure provides a display device. The display device includes a display panel, a first polarizer, and a diffuse-reflection structure. The first polarizer is disposed on a light-emitting side of the display panel. The first polarizer includes a first polarizing layer. The diffuse-reflection structure is disposed over the first polarizing layer.

### FIELD OF THE INVENTION

The present disclosure relates to the technical field of display, and specifically to a display device.

### BACKGROUND OF THE INVENTION

Currently, during a meeting in a conference room, a projection system is generally required to display the content such as PowerPoint (PPT) files, to report work information. Conventional projection systems include a projector, a projection screen (e.g., a white wall), and a computer. Due to some advantages of liquid crystal displays, such as low price, no need for the projector during projection display, high display brightness, and more excellent display effect, more and more commercial display systems are gradually replaced from conventional projection systems to liquid crystal display systems.

However, when a reporting person uses the liquid crystal display in the conference room for reporting work, a reflection characteristic of the liquid crystal display is a specular reflection. When the reporting person uses a laser pointer to emit rays onto a liquid crystal screen, only people in a reflective direction can see a light spot created by the laser pointer on the display screen. Also, people who deviate from the reflective direction are less likely to see the light spot created by the laser pointer. Then, the reporting work cannot be carried out smoothly. Thus, applications of liquid crystal displays used in commercial projection display are limited.

### SUMMARY OF THE INVENTION

The present disclosure provides a display device to solve a problem that applications of liquid crystal displays used in commercial projection display are limited due to a poor diffuse-reflection effect of a liquid crystal display.

The present disclosure provides a display device, which includes: a display panel; a first polarizer disposed on a light-emitting side of the display panel, wherein the first polarizer includes a first polarizing layer; a second polarizer disposed on one side of the first polarizer away from the display panel, wherein the display panel further includes the second polarizer; and a diffuse-reflection structure disposed over the first polarizing layer, wherein the diffuse-reflection structure includes a diffuse-reflection layer that includes a first surface and a second surface opposite to each other, wherein the first surface is a rough surface with a concave-convex shape.

In the display device of the present disclosure, the first surface is a surface of the diffuse-reflection layer away from the first polarizing layer.

In the display device of the present disclosure, the diffuse-reflection structure includes a diffuse-reflection layer and a plurality of reflective particles arranged inside the diffuse-reflection layer.

In the display device of the present disclosure, the first polarizer includes a first adhesive layer and a first compensation layer arranged in sequence, the first adhesive layer is disposed on the light-emitting side of the display panel, and the first polarizing layer is disposed on the first compensation layer.

In the display device of the present disclosure, the first polarizer further includes a first protective layer, the first polarizing layer is disposed between the first compensation layer and the first protective layer, and the diffuse-reflection layer is integrated on the first protective layer.

The present disclosure further provides a display device, which includes: a display panel; a first polarizer disposed on a light-emitting side of the display panel, wherein the first polarizer includes a first polarizing layer; and a diffuse-reflection structure disposed over the first polarizing layer.

In the display device of the present disclosure, the diffuse-reflection structure includes a diffuse-reflection layer that includes a first surface and a second surface opposite to each other, wherein the first surface is a rough surface with a concave-convex shape.

In the display device of the present disclosure, the first surface is a surface of the diffuse-reflection layer away from the first polarizing layer.

In the display device of the present disclosure, the diffuse-reflection structure includes a diffuse-reflection layer and a plurality of reflective particles arranged inside the diffuse-reflection layer.

In the display device of the present disclosure, the first polarizer includes a first adhesive layer and a first compensation layer arranged in sequence, the first adhesive layer is disposed on the light-emitting side of the display panel, and the first polarizing layer is disposed on the first compensation layer.

In the display device of the present disclosure, the first polarizer further includes a first protective layer, the first polarizing layer is disposed between the first compensation layer and the first protective layer, and the diffuse-reflection layer is integrated on the first protective layer.

In the display device of the present disclosure, the diffuse-reflection structure is a diffuse-reflection film integrated on a surface of the first polarizing layer away from the first compensation layer.

In the display device of the present disclosure, the first polarizer further includes a first protective layer, the first polarizing layer is disposed between the first compensation layer and the first protective layer, the diffuse-reflection structure is disposed on one side of the first protective layer away from the first polarizing layer, the display device further includes a second adhesive layer, and the diffuse-reflection structure is bonded to the first protective layer via the second adhesive layer.

In the display device of the present disclosure, the diffuse-reflection structure is a diffuse-reflection film or a diffuse-reflection cover.

In the display device of the present disclosure, the display panel further includes a second polarizer disposed on one side of the first polarizer away from the display panel, the second polarizer includes a second protective layer, a second polarizing layer, a second compensation layer, and a third adhesive layer arranged in sequence, and the third adhesive layer is located on one side of the second compensation layer close to the display panel.

Compared with display devices in the prior art, a display device provided by the present disclosure is equipped with a diffuse-reflection structure over the first polarizing layer, so that incident rays can be reflected in different directions, thereby enhancing a diffuse-reflection effect to the incident rays. When a reporting person in a conference room uses a laser pointer to emit rays onto a liquid crystal display screen, people can see a light spot created by the laser pointer on the display screen in various directions. Then, the content instructed by the light spot can be seen, thereby realizing applications of liquid crystal displays used in commercial projection display.

### BRIEF DESCRIPTION OF THE DRAWINGS

To explain technical solutions in embodiments of the present disclosure more clearly, the drawings needed in the description of the embodiments will be briefly introduced as follows. Obviously, the drawings used in the following description are only some embodiments of the present disclosure. Other drawings can be obtained by those skilled in the art, based on these drawings, without creative work.

FIG. 1 is a schematic structural diagram of a display device provided by a first embodiment of the present disclosure.

FIG. 2 is a first schematic structural diagram of a diffuse-reflection structure in the display device provided by the first embodiment of the present disclosure.

FIG. 3 is a second schematic structural diagram of the diffuse-reflection structure in the display device provided by the first embodiment of the present disclosure.

FIG. 4 is a schematic structural diagram of a display device provided by a second embodiment of the present disclosure.

FIG. 5 is a schematic structural diagram of a display device provided by a third embodiment of the present disclosure.

FIG. 6 is a schematic structural diagram of a display device provided by a fourth embodiment of the present disclosure.

### DETAILED DESCRIPTION OF THE PREFERRED EMBODIMENTS

Technical solutions in embodiments of the present disclosure will be clearly and completely described as below in conjunction with accompanying drawings used in the embodiments of the present disclosure. Obviously, the described embodiments are merely a part of the embodiments of the present disclosure and are not all of the embodiments. Based on the embodiments of the present disclosure, all of the other embodiments obtained by a person having ordinary skill in the art without creative work shall fall within the protection scope of the present disclosure.

It should be understood that, in the description of the present disclosure, the terms, such as “center,” “longitudinal,” “lateral,” “length,” “width,” “thickness,” “up,” “down,” “front,” “rear,” “left,” “right,” “vertical,” “horizontal,” “top,” “bottom,” “inner,” “outer,” “clockwise,” and “counterclockwise”, are used to indicate a relationship of orientations or positions based on which shown in the drawings. The terms are only used for the convenience of describing the present disclosure and simplifying the description but are not used for indicating or implying that devices or elements which are referred must have a specific orientation or be constructed and operated in the specific orientation. Therefore, the terms cannot be construed as limitations to the present disclosure. In addition, the terms “first” and “second” are merely used for illustrative purposes but are not construed as indicating or imposing relative importance or implicitly indicating the number of technical features indicated. Thus, a feature that defines “first” or “second” may expressly or implicitly include one or more of the features. In the description of the present disclosure, the meaning of “plural” is two or more, unless otherwise specified.

In the description of the present disclosure, it should be noted that unless otherwise expressly stated and defined, the terms, “install,” “interconnect,” and “connect,” should be broadly construed. For example, it may be a fixed connection, a detachable connection, or integral connection; it may be a mechanical connection, an electrical connection, or communication with each other; it may be a directed connection, an indirect connection via an intermediate medium, an internal connection between two components, or an interaction between two components. For a person having ordinary skill in the art, the specific meanings of the above terms in the present disclosure can be construed according to the specific situation.

In the present disclosure, unless otherwise expressly stated and defined, a first feature “above” or “below” a second feature may include direct contact between the first and second features, and may also include that the first and second features are not in direct contact but are in contact with another feature between the first and second features. Moreover, the first feature “upon,” “over,” and “above” the second feature includes the first feature being directly above and diagonally above the second feature or merely indicating that the first feature is higher than the second feature in horizontal height. In addition, the first feature “below,” “under,” and “beneath” the second feature includes the first feature being directly below and diagonally below the second feature or merely indicating that the first feature is lower than the second feature in horizontal height.

The disclosure herein provides many different embodiments or examples for realizing different structures of the present disclosure. In order to simplify the disclosure of the present disclosure, the parts and configurations of specific examples are described below. Certainly, they are merely examples and which do not be provided for limiting the present disclosure. In addition, the present disclosure may repeat reference numerals and/or reference letters in different examples. This repetition is used for the purpose of simplification and clarity and does not be used to indicate a relationship between the various embodiments and/or configurations that are discussed. In addition, the present disclosure provides examples of various specific processes and materials, but a person having ordinary skill in the art may be aware of applications of other processes and/or use of other materials.

It should be noted that a display panel of the present disclosure may be a liquid crystal display panel or may also be an organic light-emitting diode display panel. The following embodiments of the present disclosure only take an example that the display panel is an organic light-emitting diode display panel for illustration, but is not limited to which.

In addition, a film structure of a first polarizer and a second polarizer in the present disclosure is only for illustration, to facilitate the description of the following embodiments of the present disclosure, but should not be construed as a limitation to the present disclosure.

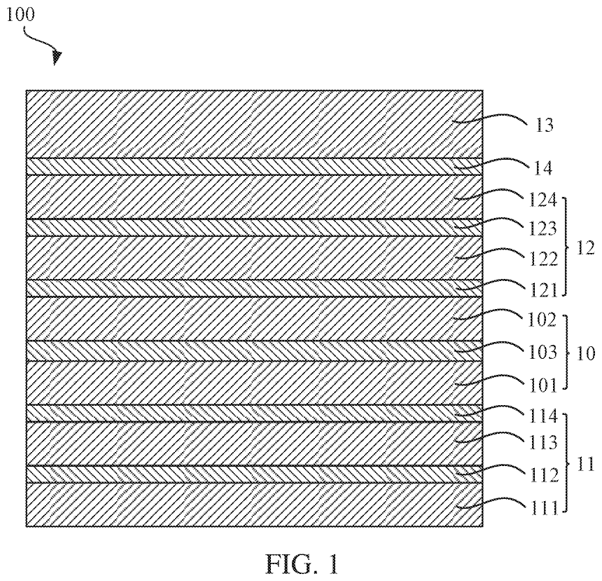

Please refer to FIGS. 1 to 3, a display device 100 provided by a first embodiment of the present disclosure includes a second polarizer 11, a display panel 10, a first polarizer 12, and a diffuse-reflection structure 13 arranged in sequence. The first polarizer 12 is disposed on a light-emitting side of the display panel 10. The first polarizer 12 includes a first polarizing layer 123. The diffuse-reflection structure 13 is disposed over the first polarizing layer 123. The second polarizer 11 is disposed on one side of the first polarizer 12 away from the display panel 10.

In this way, the display device 100 provided by the first embodiment of the present disclosure is provided with the diffuse-reflection structure 13 over the first polarizing layer 123, so that incident rays can be reflected in different directions, thereby enhancing a diffuse-reflection effect for the incident rays. When a reporting person in a conference room uses a laser pointer to emit rays onto a liquid crystal display screen, people can see a light spot created by the laser pointer on the display screen in various directions. Then, the content instructed by the light spot can be seen, thereby realizing applications of liquid crystal displays used in commercial projection display.

Understandably, an incident surface of a polarizer in a conventional liquid crystal display is a smooth surface. When a beam of parallel incident rays are emitted onto the incident surface of the polarizer, the incident rays will cause a specular reflection on the incident surface of the polarizer to exit in parallel in the same direction. Therefore, when the laser pointer emits rays onto the liquid crystal display screen, only people in a reflective direction can see a light spot created by the laser pointer on the display screen. Also, people who deviate from the reflective direction are less likely to see the light spot created by the laser pointer. In particular, because a reporting person in a conference room is at a position in an incident direction regarding the laser pointer, the reporting person himself cannot also see the light spot created by the laser pointer, which directly affects the reporting work.

In the first embodiment of the present disclosure, a diffuse-reflection structure 13 is disposed over the first polarizing layer 123 of the first polarizer 12. When a beam of parallel rays is emitted onto the incident surface of the diffuse-reflection structure 13, the incident rays are diffusely reflected on the incident surface and emitted in different directions. Then, when the reporting person uses the laser pointer to emit rays onto the liquid crystal display screen, people including the reporting person and the other viewers can see the spot formed by the laser pointer on the display screen, thereby reducing the specular reflectance of the liquid crystal display and increasing the diffuse reflectance. Further, a red light laser pointer is taken as an example, the inventor had found by calculating in a large number of experimental studies that a configuration of the diffuse-reflection structure 13 can make the diffuse reflectance of the liquid crystal display reach more than 6%.

Further, transmittance of the diffuse-reflection structure 13 is between 50% and 100%.

Specifically, in the first embodiment of the present disclosure, the transmittance of the diffuse-reflection structure 13 can reach more than 90%. Therefore, under a circumstance of enhancing the diffuse-reflection effect for the incident rays, the first embodiment can ensure the display brightness of the liquid crystal display due to the high transmittance of the diffuse-reflection structure 13, thereby ensuring a good display effect of the liquid crystal display.

In the first embodiment of the present disclosure, the first polarizer 12 further includes a first adhesive layer 121, a first compensation layer 122, and a first protective layer 124, which are sequentially arranged. The first adhesive layer 121 is disposed on the light-emitting side of the display panel 10. The first polarizing layer 123 is disposed between the first compensation layer 122 and the first protective layer 124. The diffuse-reflection structure 13 is disposed on one side of the first protective layer 124 away from the first polarizing layer 123. The display device 100 further includes a second adhesive layer 14. The diffuse-reflection structure 13 is bonded to the first protective layer 124 via the second adhesive layer 14.

Understandably, in the above configuration, by disposing the diffuse-reflection structure 13 over the first protective layer 124 on the outermost side of the first polarizer 12 and by bonding the second adhesive layer 14 with the first protective layer 124, the original manufacturing process does not need to be changed. Thus, by adding one diffuse-reflection structure 13 over the first polarizer 12, the diffuse-reflection effect for the incident rays can be enhanced.

The second adhesive layer 14 may be optical adhesive or other material with adhesive effect, which will not be repeatedly described herein.

It should be noted that in the first polarizer 12, the material of the first adhesive layer 121 may be a polypropylene-liked pressure-sensitive adhesive, the material of the first polarizing layer 123 may be polyvinyl alcohol, and the material of the first protective layer 124 may be one of or a combination of more of cellulose triacetate, polyethylene terephthalate, or polymethyl methacrylate. In the present disclosure, the materials of the first adhesive layer 121, the first compensation layer 122, the first polarizing layer 123, and the first protective layer 124 do not be specifically limited.

Please continuously refer to FIG. 2, in the first embodiment of the present disclosure, the diffuse-reflection structure 13 includes a diffuse-reflection layer 131. The diffuse-reflection layer 131 includes a first surface 131a and a second surface 131b opposite to each other. The first surface 131a is a rough surface with a concave-convex shape.

In the first embodiment of the present disclosure, the first surface 131a is a surface of the diffuse-reflection layer 131 away from the first polarizing layer 123.

Because the first surface 131a of the diffuse-reflection layer 131 is the incident surface of the incident rays, in the above configuration, by forming the first surface 131a into the rough surface with the concave-convex shape, when a beam of parallel incident rays are emitted onto the rough surface, the different incident rays have different normal directions at points on the rough surface, which makes the reflected rays come out of different directions. Namely, the reflected rays hitting the rough surface will exit in various directions, thereby enhancing the diffuse-reflection effect for the incident rays.

Specifically, the above-mentioned rough surface can be formed on the diffuse-reflection layer 131 by adopting an etching method or a photoresist melting method. The specific method for forming the rough surface is not specifically limited in the present disclosure.

In addition, the roughness of the first surface 131a can be adjusted according to the actual conditions of a manufacturing process, which is not limited in the present disclosure.

In some embodiments, the first surface 131a is a surface of the diffuse-reflection layer 131 close to the first polarizing layer 123. Because the first surface 131a is a rough surface with a concave-convex shape, the existence of which can increase a contact area between the first surface 131a and the second bonding layer 14. The cohering effect between the diffuse-reflection structure 13 and the first polarizer 12 can be increased. Thus, it can effectively prevent the diffuse-reflection structure 13 from coming off, thereby improving the performance of a product and helping to increase the service life of a liquid crystal display.

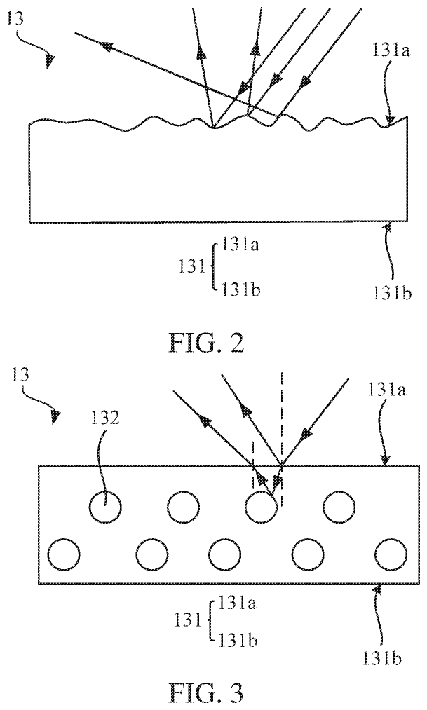

Please continuously refer to FIG. 3, the diffuse-reflection structure 13 in the first embodiment of the present disclosure can further include a diffuse-reflection layer 131 and a plurality of reflective particles 132. The diffuse-reflection layer 131 includes a first surface 131a and a second surface 131b opposite to each other. The reflective particles 132 are arranged inside the diffuse-reflection layer 131.

Understandably, the refractive index of the internal material of the diffuse-reflection layer 131 is different from the refractive index of the outside air. When a beam of parallel incident rays are directed to the first surface 131a, the incident rays will be reflected on the first surface 131a and simultaneously refracted on the first surface 131a to enter the interior of the diffuse-reflection layer 131.

In the above configuration, by arranging the reflective particles 132 inside the diffuse-reflection layer 131, such that the refracted rays entering the diffuse-reflection layer 131 is first reflected on a surface of each of the reflective particles 132, and then the reflected rays are refracted on the first surface 131a to emit from the interior of the diffuse-reflection layer 131 into the air. In this way, the refracted rays that are emitted from the interior of the diffuse-reflection layer 131 and pass through the first surface 131a can be directed in different directions, thereby significantly enhancing the diffuse-reflection effect for the incident rays.

Specifically, because the diffuse-reflection layer 131 is prepared from base material, during a preparation process of the diffuse-reflection layer 131, the base material may be doped with a plurality of reflective particles 132 to form the diffuse-reflection layer 131, wherein the reflective particles 132 are transparent particles with a high refractive index.

It should be noted that the structure of the reflective particles 132 in the first embodiment of the present disclosure is only for illustration, to facilitate the description of the various embodiments of the present disclosure. In the present disclosure, the specific number, morphology, particle size, distribution, and materials of the reflective particles 132 are not specifically limited.

In some embodiments, the diffuse-reflection structure 13 can further include a diffuse-reflection layer 131 and a plurality of reflective particles 132. The diffuse-reflection layer 131 includes a first surface 131a and a second surface 131b opposite to each other. The first surface 131a is a rough surface with a concave-convex shape. The reflective particles 132 are arranged inside the diffuse-reflection layer 131. Therefore, this configuration can further improve the diffuse reflectance of the liquid crystal display, thereby further enhancing the diffuse-reflection effect for the incident rays.

Further, in the first embodiment of the present disclosure, the diffuse-reflection structure 13 is a diffuse-reflection cover. Specifically, the diffuse-reflection cover can be prepared from a rigid substrate such as glass. In the present disclosure, the base material of the cover plate does not specifically be limited.

Because the cover has good rigidity, which can further protect the liquid crystal display, such as being able to effectively prevent the surface of the liquid crystal display from being scratched, thereby helping to increase the service life of the liquid crystal display.

In the first embodiment of the present disclosure, the display panel 10 includes an array substrate 101, a color filter substrate 102, and a liquid crystal layer 103 disposed between the array substrate 101 and the color filter substrate 102. The first polarizer 12 is disposed on the color filter substrate 102.

The second polarizer 11 includes a second protective layer 111, a second polarizing layer 112, a second compensation layer 113, and a third adhesive layer 114. The third adhesive layer 114 is disposed on one side of the second compensation layer 113 close to the display panel 10.

The first embodiment of the present disclosure provides the display device 100, by providing the diffuse-reflection cover over the first polarizing layer 123, so that the incident rays are diffusely reflected on the incident surface of the diffuse-reflection cover without changing the original manufacturing process, thereby enhancing the diffuse-reflection effect for the incident rays. When a reporting person in a conference room uses a laser pointer to emit rays onto the liquid crystal display screen, viewers can see a light spot created by the laser pointer on the display screen from different angles. Then, the viewers can see the contents which are instructed by the laser pointer, thereby realizing applications of liquid crystal displays used in commercial projection display. Furthermore, using the cover in the first embodiment of the present disclosure has a further protective effect on the liquid crystal display, such as being able to effectively prevent the surface of the liquid crystal display from being scratched, thereby improving the performance of the product and helping to increase the service life of the liquid crystal display.

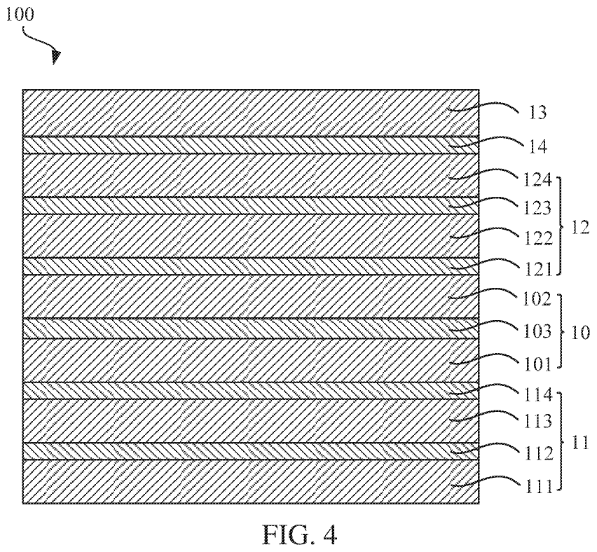

Please refer to FIG. 4, which is a schematic structural diagram of a display device provided by a second embodiment of the present disclosure. The difference between the second and first embodiments of the present disclosure is that the diffuse-reflection structure 13 is a diffuse-reflection film.

In the second embodiment, the overall thickness of the liquid crystal display can be reduced by using the diffuse-reflection film, thereby helping to enhance the market competitiveness of the product.

Specifically, in the diffuse-reflection film, the base material of the diffuse-reflection layer 131 may be one of or a combination of more of cellulose triacetate, polyethylene terephthalate, or polymethyl methacrylate. The base material does not be specifically limited in the present disclosure.

The second embodiment of the present disclosure provides the display device 100, by providing the diffuse-reflection film over the first polarizing layer 123, so that the incident rays are diffusely reflected on the incident surface of the diffuse-reflection film without changing the original manufacturing process, thereby enhancing the diffuse-reflection effect for the incident rays. When a reporting person in a conference room uses a laser pointer to emit rays onto the liquid crystal display screen, viewers can see a light spot created by the laser pointer on the display screen from different angles. Then, the viewers can see the contents which are instructed by the laser pointer, thereby realizing applications of liquid crystal displays used in commercial projection display. Furthermore, in the second embodiment of the present disclosure, the overall thickness of the liquid crystal display can be reduced by using the diffuse-reflection film, thereby helping to enhance the market competitiveness of the product.

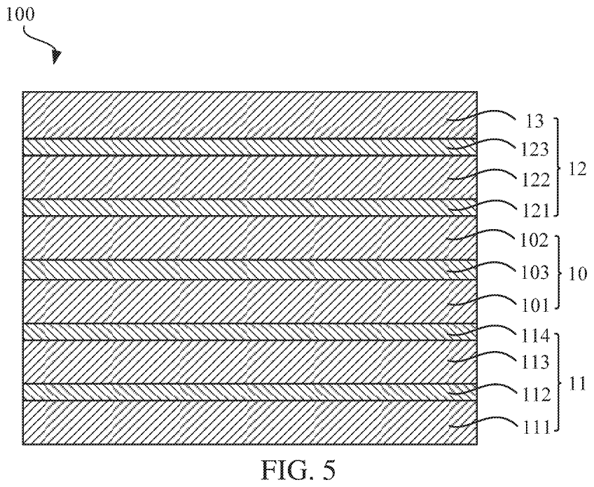

Please refer to FIG. 5, which is a schematic structural diagram of a display device provided by a third embodiment of the present disclosure. The difference between the third and first embodiments of the present disclosure is that the first polarizer 12 includes a first adhesive layer 121 and a first compensation layer 122 arranged in sequence, wherein the first adhesive layer 121 is disposed on a light-emitting side of the display panel 10, a first polarizing layer 123 is disposed on the first compensation layer 122, the diffuse-reflection structure 13 is a diffuse-reflection film, and the diffuse-reflection film is integrated on a surface of the first polarizing layer 123 away from the first compensation layer 122.

Understandably, when a performance test of the liquid crystal display is performed under conditions of high temperature and high humidity, the first polarizer 12 and the second polarizer 11 are susceptible to heat and moisture in the environment of high temperature and high humidity, which will cause shrinkage or expansion. When a thickness difference between the first polarizer 12 and the second polarizer 11 is large, there will be a stress difference between the first polarizer 12 and the second polarizer 11, which will cause that the display panel 10 which is bonded with the first polarizer 12 and the second polarizer 11 deforms. As a result, the liquid crystal layer 103 in the display panel 10 is easily bent and deformed, thereby affecting the display effect of the display panel 10.

In the above configuration, by integrating the diffuse-reflection film on the first polarizer layer 123, the thickness difference between the first polarizer 12 and the second polarizer 11 is reduced. Then, the stress difference between the first polarizer 12 and the second polarizer 11 is reduced, thereby improving the display effect of the display panel 10.

Specifically, in the diffuse-reflection film, the base material of the diffuse-reflection layer 131 may be one of or a combination of more of cellulose triacetate, polyethylene terephthalate, or polymethyl methacrylate. Also, the material, such as cellulose triacetate, polyethylene terephthalate, or polymethyl methacrylate, has advantages of high strength and excellent support performance. Therefore, the diffuse-reflection film can play a good role in supporting and protecting the liquid crystal display.

The third embodiment of the present disclosure provides the display device 100, by integrating a diffuse-reflection film on a surface of the first polarizing layer 123 away from the first compensation layer 122, the incident rays are diffusely reflected on the incident surface of the diffuse-reflection film, thereby enhancing the diffuse-reflection effect for the incident rays. When a reporting person in a conference room uses a laser pointer to emit rays onto the liquid crystal display screen, viewers can see a light spot created by the laser pointer on the display screen from different angles. Then, the viewers can see the contents which are instructed by the laser pointer, thereby realizing applications of liquid crystal displays used in commercial projection display. Furthermore, the above configuration reduces the thickness difference between the first polarizer 12 and the second polarizer 11, which reduces the stress difference between the first polarizer 12 and the second polarizer 11, thereby improving the display effect of the display panel 10.

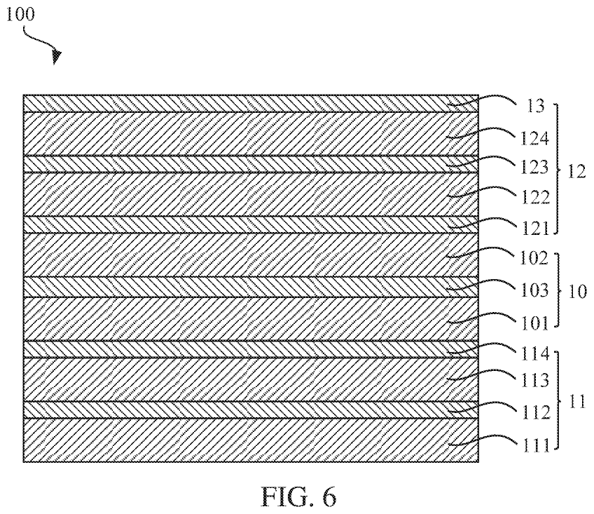

Please refer to FIG. 6, which is a schematic structural diagram of a display device provided by a fourth embodiment of the present disclosure. The difference between the fourth and first embodiments of the present disclosure is that the diffuse-reflection structure 13 is integrated on the first protective layer 124.

Specifically, the diffuse-reflection layer 131 is integrated on a surface of the first protective layer 124 away from the first polarizing layer 123.

Understandably, when a performance test of the liquid crystal display is performed under conditions of high temperature and high humidity, the first polarizer 12 and the second polarizer 11 are susceptible to heat and moisture in the environment of high temperature and high humidity, which will cause shrinkage or expansion. When a thickness difference between the first polarizer 12 and the second polarizer 11 is large, there will be a stress difference between the first polarizer 12 and the second polarizer 11, which will cause that the display panel 10 which is bonded with the first polarizer 12 and the second polarizer 11 deforms. As a result, the liquid crystal layer 103 in the display panel 10 is easily bent and deformed, thereby affecting the display effect of the display panel 10.

In the above configuration, by integrating the diffuse-reflection layer 131 on the first protective layer 124, the thickness difference between the first polarizer 12 and the second polarizer 11 is reduced. Then, the stress difference between the first polarizer 12 and the second polarizer 11 is reduced, thereby improving the display effect of the display panel 10 and enhancing the performance of the product.

In some embodiments, the diffuse-reflection layer 131 is a layer of coating structure. Specifically, a surface of the first protective layer 124 away from the first polarizing layer 123 is coated or sprayed with silica or resin and is designed into a scattered-surface layer with a concave-convex shape to form the coating structure, thereby enhancing the diffuse-reflection effect for the incident rays. Because the coating structure is relatively thin, the thickness difference between the first polarizer 12 and the second polarizer 11 can be reduced, thereby also reducing the stress difference between the first polarizer 12 and the second polarizer 11. Thus, the display effect of the display panel 10 can be significantly improved, which improves the performance of the product, which is conducive to enhancing the market competitiveness of the product.

The fourth embodiment of the present disclosure provides the display device 100, by integrating a diffuse-reflection layer 131 on the first protective layer 124, the incident rays are diffusely reflected on the incident surface of the diffuse-reflection layer 131, thereby enhancing the diffuse-reflection effect for the incident rays. When a reporting person in a conference room uses a laser pointer to emit rays onto the liquid crystal display screen, viewers can see a light spot created by the laser pointer on the display screen from different angles. Then, the viewers can see the contents which are instructed by the laser pointer, thereby realizing applications of liquid crystal displays used in commercial projection display. Furthermore, the above configuration reduces the thickness difference between the first polarizer 12 and the second polarizer 11, which reduces the stress difference between the first polarizer 12 and the second polarizer 11, thereby improving the display effect of the display panel 10, which enhances the performance of the product.

Compared with display devices in the prior art, a display device provided by the present disclosure is equipped with a diffuse-reflection structure over the first polarizing layer, so that incident rays can be reflected in different directions, thereby enhancing a diffuse-reflection effect to the incident rays. When the reporting person in the conference room uses the laser pointer to emit rays onto the liquid crystal screen, people can see the light spot created by the laser pointer on the display screen in various directions. Then, the content instructed by the light spot can be seen, thereby realizing applications of liquid crystal displays used in commercial projection display.

The embodiments of the present disclosure are described in detail as above, and specific examples are used herein to illustrate the principles and implementations of the present disclosure. The descriptions of the above examples are only used to help in understanding the methods and core ideas of the present disclosure. Meanwhile, a person having ordinary skill in the art can change the specific implementation and scope of the present disclosure based on ideas thereof. In summary, the content of the present disclosure should not be construed as a limitation to the present disclosure.

1. A display device, comprising:
a display panel;
a first polarizer disposed on a light-emitting side of the display panel, wherein the first polarizer comprises a first polarizing layer;
a second polarizer disposed on one side of the display panel away from the first polarizer; and
a diffuse-reflection structure disposed over the first polarizing layer, wherein the diffuse-reflection structure comprises a diffuse-reflection layer that comprises a first surface and a second surface opposite to each other, the first surface is a rough surface with a concave-convex shape, and transmittance of the diffuse-reflection structure is between 50% and 100%.

2. The display device as claimed in claim 1, wherein the first surface is a surface of the diffuse-reflection layer away from the first polarizing layer.

3. The display device as claimed in claim 1, wherein the diffuse-reflection structure comprises a plurality of reflective particles arranged inside the diffuse-reflection layer.

4. The display device as claimed in claim 3, wherein the first polarizer comprises a first adhesive layer and a first compensation layer arranged in sequence, the first adhesive layer is disposed on the light-emitting side of the display panel, and the first polarizing layer is disposed on the first compensation layer.

5. The display device as claimed in claim 4, wherein the first polarizer further comprises a first protective layer, the first polarizing layer is disposed between the first compensation layer and the first protective layer, and the diffuse-reflection layer is integrated on the first protective layer.

6. A display device, comprising:
a display panel;
a first polarizer disposed on a light-emitting side of the display panel, wherein the first polarizer comprises a first polarizing layer; and
a diffuse-reflection structure disposed over the first polarizing layer, wherein transmittance of the diffuse-reflection structure is between 50% and 100%.

7. The display device as claimed in claim 6, wherein the diffuse-reflection structure comprises a diffuse-reflection layer that comprises a first surface and a second surface opposite to each other, and the first surface is a rough surface with a concave-convex shape.

8. The display device as claimed in claim 7, wherein the first surface is a surface of the diffuse-reflection layer away from the first polarizing layer.

9. The display device as claimed in claim 6, wherein the diffuse-reflection structure comprises a diffuse-reflection layer and a plurality of reflective particles arranged inside the diffuse-reflection layer.

10. The display device as claimed in claim 7, wherein the first polarizer comprises a first adhesive layer and a first compensation layer arranged in sequence, the first adhesive layer is disposed on the light-emitting side of the display panel, and the first polarizing layer is disposed on the first compensation layer.

11. The display device as claimed in claim 9, wherein the first polarizer comprises a first adhesive layer and a first compensation layer arranged in sequence, the first adhesive layer is disposed on the light-emitting side of the display panel, and the first polarizing layer is disposed on the first compensation layer.

12. The display device as claimed in claim 10, wherein the first polarizer further comprises a first protective layer, the first polarizing layer is disposed between the first compensation layer and the first protective layer, and the diffuse-reflection layer is integrated on the first protective layer.

13. The display device as claimed in claim 11, wherein the first polarizer further comprises a first protective layer, the first polarizing layer is disposed between the first compensation layer and the first protective layer, and the diffuse-reflection layer is integrated on the first protective layer.

14. The display device as claimed in claim 10, wherein the diffuse-reflection structure is a diffuse-reflection film integrated on a surface of the first polarizing layer away from the first compensation layer.

15. The display device as claimed in claim 11, wherein the diffuse-reflection structure is a diffuse-reflection film integrated on a surface of the first polarizing layer away from the first compensation layer.

16. The display device as claimed in claim 10, wherein the first polarizer further comprises a first protective layer, the first polarizing layer is disposed between the first compensation layer and the first protective layer, the diffuse-reflection structure is disposed on one side of the first protective layer away from the first polarizing layer, the display device further comprises a second adhesive layer, and the diffuse-reflection structure is bonded to the first protective layer via the second adhesive layer.

17. The display device as claimed in claim 11, wherein the first polarizer further comprises a first protective layer, the first polarizing layer is disposed between the first compensation layer and the first protective layer, the diffuse-reflection structure is disposed on one side of the first protective layer away from the first polarizing layer, the display device further comprises a second adhesive layer, and the diffuse-reflection structure is bonded to the first protective layer via the second adhesive layer.

18. The display device as claimed in claim 16, wherein the diffuse-reflection structure is a diffuse-reflection film or a diffuse-reflection cover.

19. The display device as claimed in claim 17, wherein the diffuse-reflection structure is a diffuse-reflection film or a diffuse-reflection cover.

20. The display device as claimed in claim 6, wherein the display panel further comprises a second polarizer disposed on one side of the display panel away from the first polarizer, the second polarizer comprises a second protective layer, a second polarizing layer, a second compensation layer, and a third adhesive layer arranged in sequence, and the third adhesive layer is located on one side of the second compensation layer close to the display panel.
